(19) United States
(12) Patent Application Publication
(10) Pub. No.: US 2024/0104643 A1
(43) Pub. Date: Mar. 28, 2024

(54) REAL TIME BIDDING METHOD

(71) Applicant: FRANK MESSINEO, TOTOWA, NJ (US)

(72) Inventor: FRANK MESSINEO, TOTOWA, NJ (US)

(21) Appl. No.: 18/519,570

(22) Filed: Nov. 27, 2023

Related U.S. Application Data
(63) Continuation-in-part of application No. 15/816,489, filed on Nov. 17, 2017, now abandoned.
(60) Provisional application No. 62/424,049, filed on Nov. 18, 2016.

(51) Int. Cl. G06Q 30/08; G06Q 30/0283; G06Q 30/0601

(52) U.S. Cl. CPC G06Q 30/08; G06Q 30/0283; G06Q 30/0609; G06Q 30/0611

(57) ABSTRACT

A bidding system and method may include a communication network based portal that communicates with a server the communications network. An architect or manager enters project information into a project database to solicit bids from any number of general contractors or the like. The general contractor may, in turn, send each selected subcontractor an invitation to contribute to their bid. The general contractor uses the bid information from the subcontractors to prepare and submit a bid to the architect or manager via the bidding system.

### CLAIM OF PRIORITY

This application is a U.S. Continuation-In-Part entitled, “REAL TIME BIDDING METHOD” and is co-pending with U.S. Non-Provisional Utility Pat. No. 15,816,489 filed Nov. 17, 2017, entitled “REAL TIME BIDDING METHOD” which claims priority to U.S. Provisional Patent Application No. 62/424,049, filed Nov. 18, 2016, both of which are incorporated by reference herein in their entirety.

### FIELD OF THE EMBODIMENTS

The field of the embodiments of the present invention relates to systems and methods for streamlining the management of the entire bidding process. Namely, the posting, preview, dissemination, acceptance, evaluation, and award of Project Bids in a standardized format over a communications network and allowing project information to be readily viewed, collated, and disseminated. The invention also includes an expanding database for clients, projects, and project costing, as well as for contractor evaluation and using machine learning, consistently updates the database based upon the most recent project data.

### BACKGROUND OF THE EMBODIMENTS

The job of the architect or project manager involves more than just designing and preparing construction documents for projects, overseeing the work, addressing issues that might arise during the project, processing invoices for payment to the general contractor, and conducting the final walk through to ensure that the job was completed as contracted; an important component of any project is that the manager must also coordinate the entire bidding process, which involves, solicitation of the bid packages, posting & preview & printing or downloading of the Contract Documents by prospective contractors, along with managing the process including Requests for Information, Pre-Bid Walk-throughs, Submitting Addenda and Clarifications, Soliciting Bidders (again, if the list of interested bidders is short), Conducting a Bid Opening and receiving bids from eligible contractors, reviewing & evaluating those contractor bids for compliance and recommending award of the bid to the desired general contractor team.

Until now, the current process for procurement of bids for any project, including the posting, preview, solicitation, dissemination, evaluation, and award of a Project has not been a simple task. Up until this point, everything needed to be done manually. The reason for this is lack of a consistent, automated method and system for use not only, by Architects and Owners, but by general contractors and subcontractors alike. Considering that the typical bidding process has the Architects soliciting bids from as few as three (3) contractors but as many as twenty (20+); the management of this information can be daunting. In addition, general contractors typically solicit bids from at least three subcontractors in each trade category, and an average job may include subcontractor bids from over one hundred possible companies. In addition to most likely presenting the bids from the different trades in different orders, different general contractors may include specific work in different trade categories.

At the end of the day, the Architect/Manager is often left to the task of deciphering bids from multiple general contractors who all present their information in different formats and who each solicit bids from dozens of subcontractors, with none of the subcontractors using the same software and all with varying degrees of detail. Normally, these bids are entered manually into a spreadsheet which is often stored locally on a computer in a non-standard format selected by whichever hardware or software platform is in used in the architect or Owner's local office. It has been difficult and onerous for the professionals to manually collate and evaluate the individual bid packages as well as share the results of those evaluations with the Owner, Reporting Agencies, and Individual Contractors using traditional manual methods, due to the above challenges. This has often times resulted in extensive delays in evaluating and processing the Bid Packages and ultimately being able to make the award to the responsive bidder; this can also lead to contractors withdrawing a viable bid because they may have received approvals on another job that they submitted. Currently, professionals must continually respond to countless phone calls and questions from the Owner, reporting agencies, and contractors looking for the results of the submitted bids; this information, is often-times incomplete since the records are not timely or readily-shared or cannot be completed due to various format inconsistencies. As a result, before a bid is awarded by the Architect or Manager, hours of work are typically spent double-checking bids, confirming inclusions and exclusions by all contractors, and recalculating bid amounts.

Thus, a need, therefore, exists for a multi-tiered web-based software system that embeds in the end-user's own website and allows a manager to dictate the format and level of detail that will be presented for not only the general contractors supplying bids, but all of the subcontractors of those general contractors as well. The software makes it possible to collect, consolidate, and organize bidding information from multiple and various contractors into a standardized format and store it in a network-based database which can be later mined to obtain, local, regional, and national cost information based on project type; it can also provide rating information for contractors who register with the system and complete projects. The present invention and its embodiments meets and exceeds these objectives.

### Review of Related Technology:

U.S. Pat. No. 7,783,554 pertains to systems and methods for securely archiving detailed bid information for later use in change order negotiation, conflict resolution, or other matters. A bid containing detailed information is received at a central archive server. Upon receipt of the bid, the server timestamps and encrypts the bid. A decryption key is provided to the party who submitted the bid. The encrypted bid is then stored in a data storage area for later use. The archived bid can be compressed to optimize data storage. Upon a request by the party who submitted the bid, the bid is retrieved from data storage, decompressed if necessary, and decrypted with a key provided by the requesting party. The detailed bid information can then be used to resolve disputes, negotiate change orders, or otherwise.

U.S. Patent Application 2008/0103958 pertains to a construction bidding system and method that includes manager, general contractor and subcontractor workstations that communicate with a server hosting a website over a network such as the Internet. The server also communicates with a number of databases. A manager enters project information into a project database and selects general contractors from a general contractor database. The manager sends each selected general contractor an invitation to bid. A general contractor receives the invitation to bid, reviews the project information and selects subcontractors from a subcontractor database. The general contractor sends each selected subcontractor an invitation to bid. A subcontractor receives the invitation to bid and responds with bid information that is entered in to a bid database. The general contractor uses the bid information from the subcontractors to prepare and submit a bid to the manager.

U.S. Patent Application 2003/0101127 pertains to an Internet-based construction bid management system that can be accessed and utilized by construction project owners, general contractors, subcontractors, vendors, and other parties interested in the construction bidding process. The system accommodates the posting of projects, the submission of bids, the distribution of construction drawings, and the collection of historical bid results, via any number of networked computer devices. The automated nature of the system ensures that the current bid status of any number of projects can be quickly updated for immediate access by the various participants.

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

In general, the present invention and its embodiments provide for a bidding system and method may include a communication network-based portal that communicates with a server the communications network and can be embedded into the end-user's website. An architect, technical assistant or manager enters project information into a project database to solicit bids from any number of general contractors or the like. The general contractor may, in turn, send each selected subcontractor an invitation to contribute to their bid. The general contractor uses the bid information from the subcontractors to prepare and submit a bid to the architect or manager via the bidding system.

In at least one embodiment of the present invention there is a computer program embodied in a non-transitory computer-readable medium comprising computer readable instructions, which when executed by a processor, cause the processor to perform the steps of: establishing, via the processor, a bid portal for at least one project; soliciting, via the processor, an invitation to make a bid by at least one bidder; receiving, via the processor, at least one bid for the at least one project; analyzing, via the processor, the at least one bid for compliance with the requirements listed in the bid portal; accepting, via the processor, the at least one bid for inclusion in a bid pool to be later evaluated.

In another embodiment of the present invention there is a system for bid management, the system comprising: a computing device having a display, wherein the computing device has at least a processor and a memory, the memory being communicatively coupled to the processor and the memory storing computer readable instructions that when executed by the processor cause the processor to perform the steps of: establishing, via the processor, a bid portal for at least one project, wherein the bid portal comprises a name, dates for pre-bid meetings, bid due date, last day for RFI's, location, budget, project type, project contact, contract documents, specifications, and diagrams; soliciting, via the processor, and from a collected database of eligible contractors, an invitation to make a bid by at least one bidder, wherein the at least one bidder meets an eligibility criteria; receiving, via the processor, at least one bid for the at least one project; analyzing, via the processor, the at least one bid for compliance with the bid portal, wherein if non-compliance is noted, then a notification is send to the at least one bidder; and accepting, via the processor, the at least one bid for inclusion in a bid pool.

In another embodiment of the present invention there is a computer implemented method of bid management of at least one user, the method comprising the steps of: establishing, via the processor, a bid portal for at least one project, wherein the bid portal comprises a named, date, location, budget, project contact, and diagrams; soliciting, via the processor, an invitation to make a bid by at least one bidder, wherein the at least one bidder meets an eligibility criteria; receiving, via the processor, at least one bid for the at least one project; analyzing, via the processor, the at least one bid for compliance with the bid portal, wherein if non-compliance is noted, then a notification is sent to the at least one bidder; and accepting, via the processor, the at least one bid for inclusion in a bid pool.

In general, the present invention succeeds in conferring the following, and others not mentioned, benefits and objectives.

It is an object of the present invention to provide a system that provides for the entire bidding process to be managed through a GUI, which involves, solicitation of the bid packages, posting & preview & printing or downloading of the Contract Documents by prospective contractors, along with managing the process including Requests for Information, Pre-Bid Walk-throughs, Submitting Addenda and Clarifications, Soliciting Bidders (again, if the list of interested bidders is short), Conducting a Bid Opening and receiving bids from eligible contractors, reviewing & evaluating those contractor bids for compliance and recommending award of the bid to the desired general contractor team.

It is an object of the present invention to provide a system that allows the Architect/manager to upload Projects to a web-based portal for the purpose of solicitation of bidders; projects are entered by project type, ie Roofing, Windows, Doors, Classroom Renovations, etc. and as such can be directly solicited to specialty contractors or general contractors who have previously registered and are in the database or those who will register.

It is an object of the present invention to provide a system that enables potential bidders to register on the portal which captures their company information including name, address, contact information, trade or company type, and allows them to review current projects available for bid including pre-viewing and download of the construction documents for a construction project over a communications network.

It is an object of the present invention to provide a system that allows electronic messages to be sent to individuals/companies interested in a particular construction project.

It is an object of the present invention to provide a system that collects a database of bidders and allows bidders to be rated and scored based upon their performance on the project; the rating is based upon Overall Construction Performance, Paperwork, Project Coordination, & Subcontractor Performance.

It is an object of the present invention to provide a system that enables document uploads and downloads including a contractors ability to procure contract documents, RFI's, Addenda & Clarifications, required bid forms.

It is an object of the present invention to provide a system that enables project modification through the inclusion of project alternates and bid acceptance scenarios.

It is an object of the present invention to provide a system that shows biddable items as part of a construction project, including base bid and at least one project alternate.

It is an object of the present invention to send out automated reminders via electronic mail, that highlight important project related dates such as pre-bid meeting date, last day for questions date, and bid opening date.

It is an object of the present invention to provide a system that allows for the collection of the base bids, and alternates during a formal bid opening and the ability to mathematically, calculate those submitted pricing for each contractor and provide a collated, spreadsheet, sorted from lowest to highest bidder according to the base bid and each of the selected alternates.

It is an object of the present invention to provide a system that allows for the storage, calculation, and data mining of the submitted pricing which results in a unified Cost Database, capable of calculating the cost per square foot or cost per unit for the current project and a variety of project types; costs can be optimized either locally, regionally or nationwide.

### BRIEF DESCRIPTION OF THE DRAWINGS

FIG. 1 is an illustration of a device showing an operational sequence for an account dashboard that may be performed when running a bidding system in accordance with some embodiments.

FIG. 2 is an illustration of a device showing an operational sequence for an account dashboard that may be performed when running a bidding system in accordance with some embodiments.

FIG. 3 is an illustration of a device showing an operational sequence for a project dashboard that may be performed when running a bidding system in accordance with some embodiments.

FIG. 4 is an illustration of a device showing an operational sequence for a project setup and maintenance dashboard that may be performed when running a bidding system in accordance with some embodiments.

FIG. 5 is an illustration of a device showing an operational sequence for a project setup that may be performed when running a bidding system in accordance with some embodiments.

FIG. 6 is an illustration of a device showing an operational sequence for a project setup that may be performed when running a bidding system in accordance with some embodiments.

FIG. 7 is an illustration of a device showing an operational sequence for a project setup that may be performed when running a bidding system in accordance with some embodiments.

FIG. 8 is an illustration of a device showing an operational sequence for a project setup that may be performed when running a bidding system in accordance with some embodiments.

FIG. 9 is an illustration of a device showing an operational sequence for a project setup that may be performed when running a bidding system in accordance with some embodiments.

FIG. 10 is an illustration of a device showing an operational sequence for a project setup that may be performed when running a bidding system in accordance with some embodiments.

FIG. 11 is an illustration of a device showing an operational sequence for a project setup having a bidders list section that may be performed when running a bidding system in accordance with some embodiments.

FIG. 12 is an illustration of a device showing an operational sequence for a bidder setup dashboard that may be performed when running a bidding system in accordance with some embodiments.

FIG. 13 is an illustration of a device showing an operational sequence for a bidder setup and maintenance dashboard that may be performed when running a bidding system in accordance with some embodiments.

FIG. 14 is an illustration of a device showing an operational sequence for a bidder electronic message portal that may be performed when running a bidding system in accordance with some embodiments.

FIG. 15 is an illustration of a device showing an operational sequence for contractor rating report that may be performed when running a bidding system in accordance with some embodiments.

FIG. 16 is an illustration of a device showing an operational sequence for a document generator that may be performed when running a bidding system in accordance with some embodiments.

FIG. 17 is an illustration of a device showing an operational sequence for a bidder type dashboard that may be performed when running a bidding system in accordance with some embodiments.

FIG. 18 is an illustration of a device showing an operational sequence for a client dashboard that may be performed when running a bidding system in accordance with some embodiments.

FIG. 19 is an illustration of a device showing an operational sequence for a rebid feature that may be performed when running a bidding system in accordance with some embodiments.

FIG. 20 is an illustration of a device showing an operational sequence for an export excel blank tabulation sample that may be performed when running a bidding system in accordance with some embodiments.

FIG. 21 is an illustration of a device showing an operational sequence for an export excel bid tabulation sample that may be performed when running a bidding system in accordance with some embodiments.

FIG. 22 is an illustration of a device showing an operational sequence for a bidder and visitor dashboard that may be performed when running a bidding system in accordance with some embodiments.

FIG. 23 is an illustration of a device showing an operational sequence for a bidder dashboard that may be performed when running a bidding system in accordance with some embodiments.

FIG. 24 is an illustration of a device showing an operational sequence for a view bidder list that may be performed when running a bidding system in accordance with some embodiments.

FIG. 25 is a block diagram illustrating a computer program, according to some embodiments of the present disclosure.

FIG. 26 is a block diagram illustrating a system, according to some embodiments of the present disclosure.

FIG. 27 is a flowchart illustrating a method, according to some embodiments of the present disclosure.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Systems, Devices and Operating Systems

Typically, a user or users, which may be people or groups of users and/or other systems, may engage information technology systems (e.g., computers, handhelds, tablets) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components. The system is primarily accessed through a web-based portal that resides on the end-user's server or CPU system.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+ EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonB all and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allows logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to:

Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like. The system contains a collection of input data which allows for the storage, accessibility, manipulation, calculation and output of data through various reporting features. Included databases consist of Cost Data—unit costs per sq. foot or by quantity for each Project Type entered; Contractor Data—Contractor information by each contractor and contractor trade or type, and a contractor rating system which rates each registered contractor who has completed a project by their performance.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft Windows 2000/2003/3.1/95/98/CE/Millennium/NT/Vista/XP (Server), and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or.NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as or FireFox or Google Chrome (Microsoft Internet Explorer, Netscape Navigator-Discontinued). Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

### EMBODIMENTS OF THE PRESENT INVENTION

In practice, the system is comprised of two portals set up via a communications network. One is the Administrative portal for the end-user, architect, or manager, in accordance with the screenshots below, would set up each project with all of the relevant project information including the bidding/contract documents. The second portal is the Contractor/Bidder or Visitor Web-Portal which takes the form of a separate page on the end-user's website that is accessed by those interested in bidding or reporting the projects. Each user will be able to view the Bidding Portal to see the Current Projects by simply going to the noted URL. Should a contractor see a project of interest, the can then proceed to preview the documents and then decide to procure and download the documents. In order to procure and download the documents, the system requires each first-time user to register for the site and create an account; they will register as an Owner, Contractor, Reporting Agency or other. Returning or previously registered users will be prompted to log-into their account in order to procure the project bid documents. A user account only has to be created once in order for that user to be able to access the system. Once registered, the user or potential bidder will be able to view the specific project information inputted by the manager and receive updates, Addenda, Clarifications for the project. The bidder then accesses each of the projects to review the needs and gather the necessary documents from the portal. The bidder can formulate a bid using their own company and/or various subcontractors. The bidder can then submit their bid to the portal for view and potential selection by the Architect/Manager/Owner.

Further, all other aspects of the bid process between the manager and the bidder(s) is fully automated by the portal described herein. Addenda and clarifications can be issued, meetings can be scheduled, emails sent to bidders or managers, etc. This “one stop shop” allows the bidding process to be streamlined in a way that saves time, money, and ensures proper turnaround of the bids received which in turn increases the chances of improving the overall quality of the work performed.

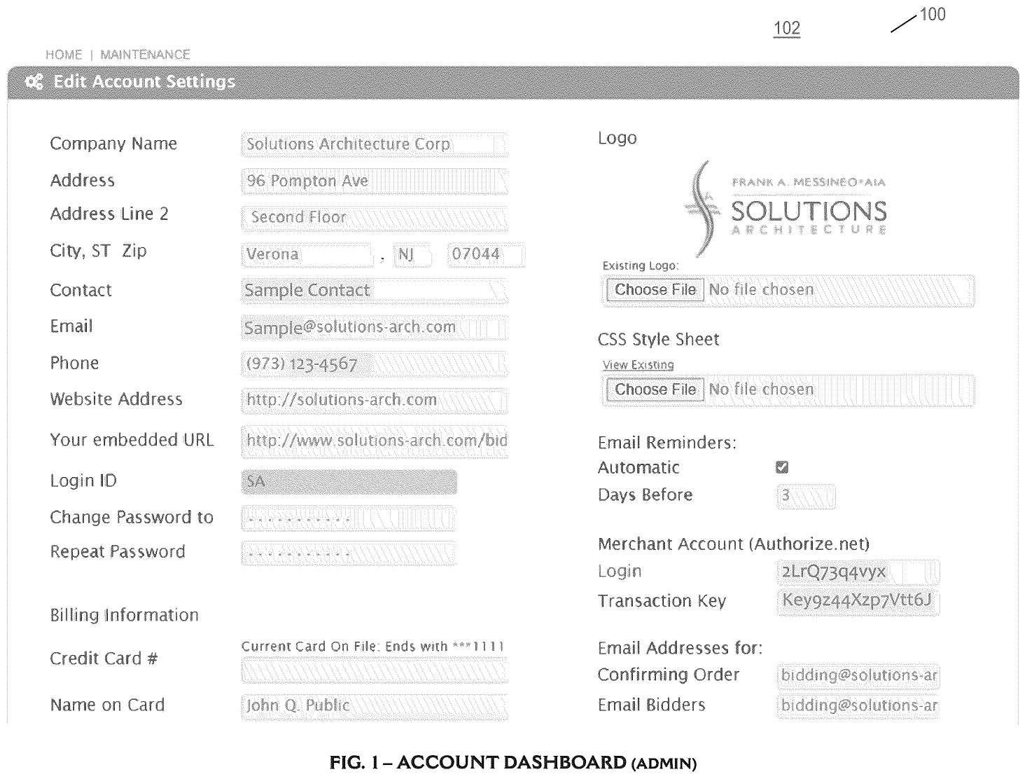

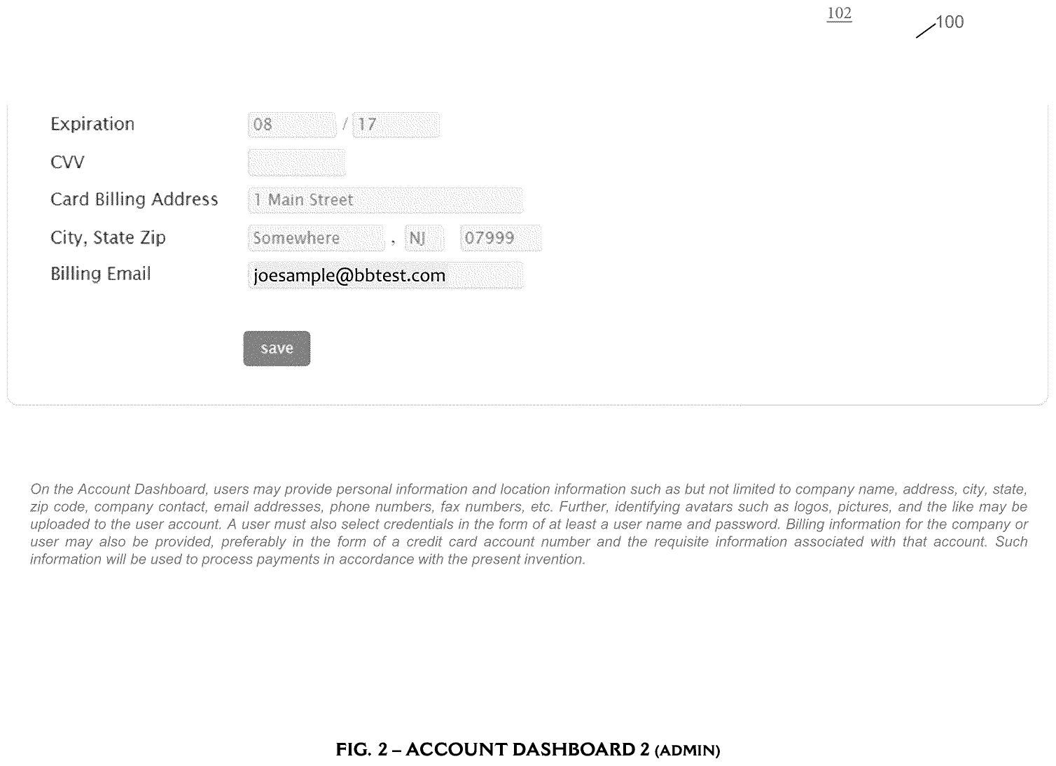

FIGS. 1 and 2 show a device 100 such as a computer display, a smartphone, and/or a tablet showing an operational sequence 102 for an account dashboard that may be performed when running the bidding system. An Account Dashboard consistent with the present invention is displayed. As shown, when first signing up to use the service, one must create an account through this dashboard. Users may provide personal information and location information such as but not limited to company name, address, city, state, zip code, company contact, email addresses, phone numbers, fax numbers, etc. Further, identifying avatars such as logos, pictures, and the like may be uploaded to the user account. A user must also select credentials in the form of at least a user name and password. Billing information for the company or user may also be provided, preferably in the form of a credit card account number and the requisite information associated with that account. Such information will be used to process payments in accordance with the present invention.

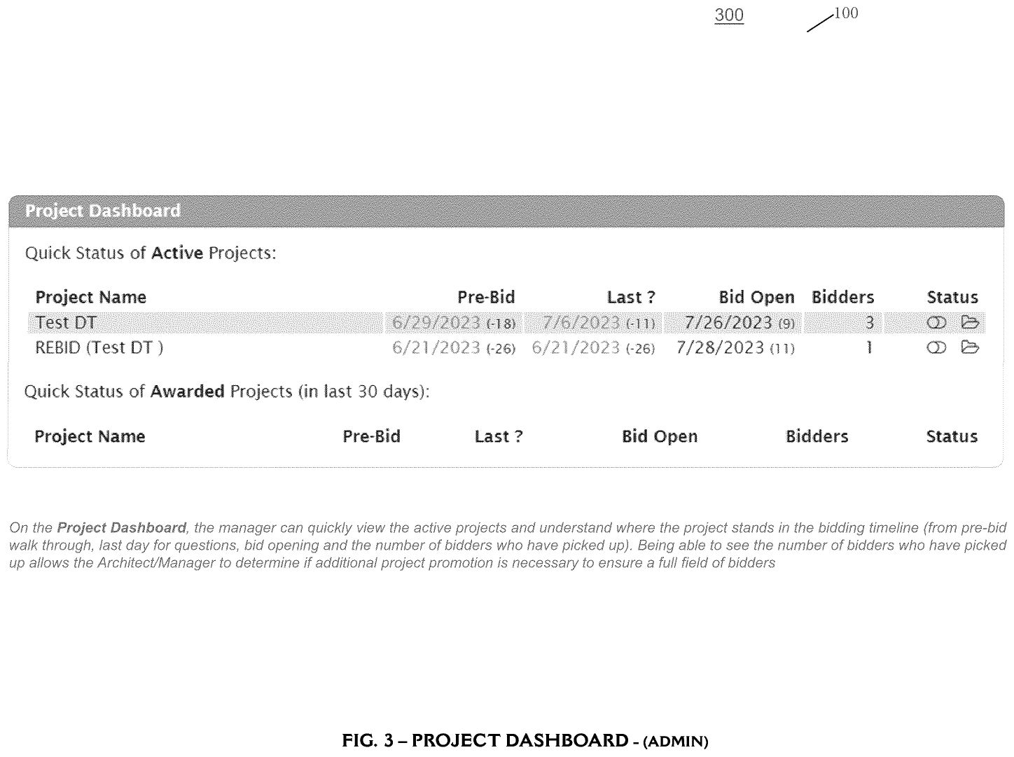

FIG. 3 is an illustration of a device 100 showing an operational sequence 300 for a project dashboard that may be performed when running the bidding system. The Project Status dashboard is an interface where the manager can quickly view the active projects and understand where the project stands in the bidding timeline (from pre-bid walk through, last day for questions, bid opening and the number of bidders who have picked up). Being able to see the number of bidders who have picked up allows the Architect/Manager to determine if additional project promotion is necessary to ensure a full field of bidders.

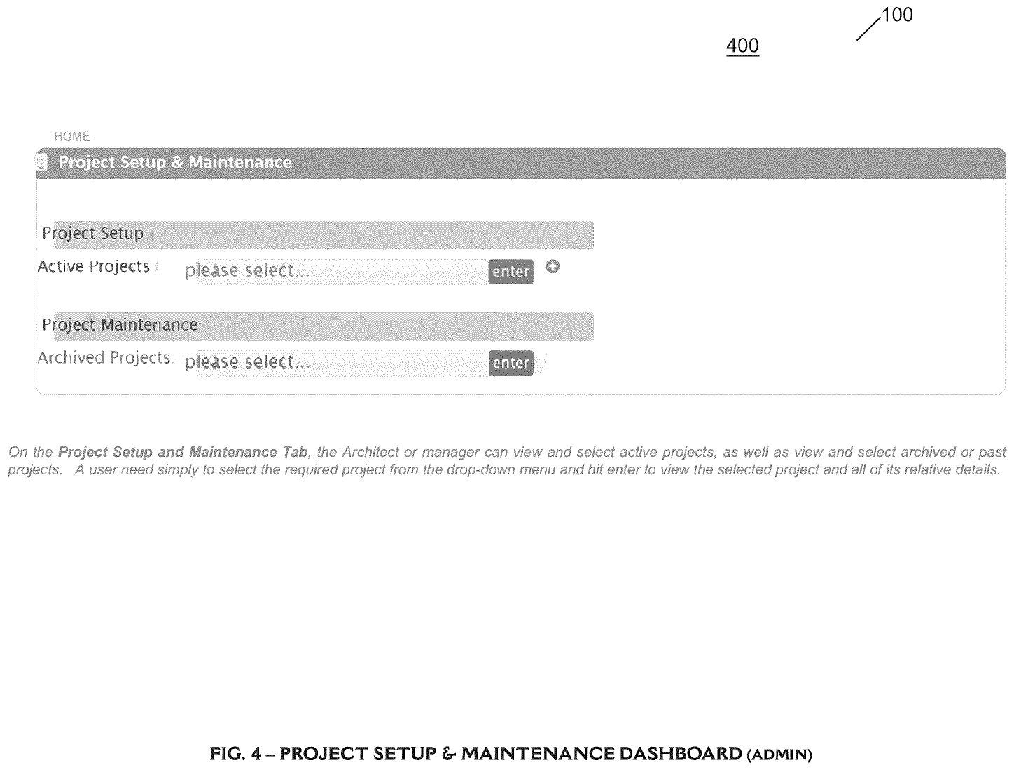

FIG. 4 is an illustration of a device 100 showing an operational sequence 400 for a project setup and maintenance dashboard that may be performed when running the bidding system. The Project Setup and Maintenance dashboard is an interface in which the Architect and/or manager can view and select active projects, as well as view and select archived or past projects. A user selects the required project from the drop down menu and hit enter to view the selected project and all of its relative details.

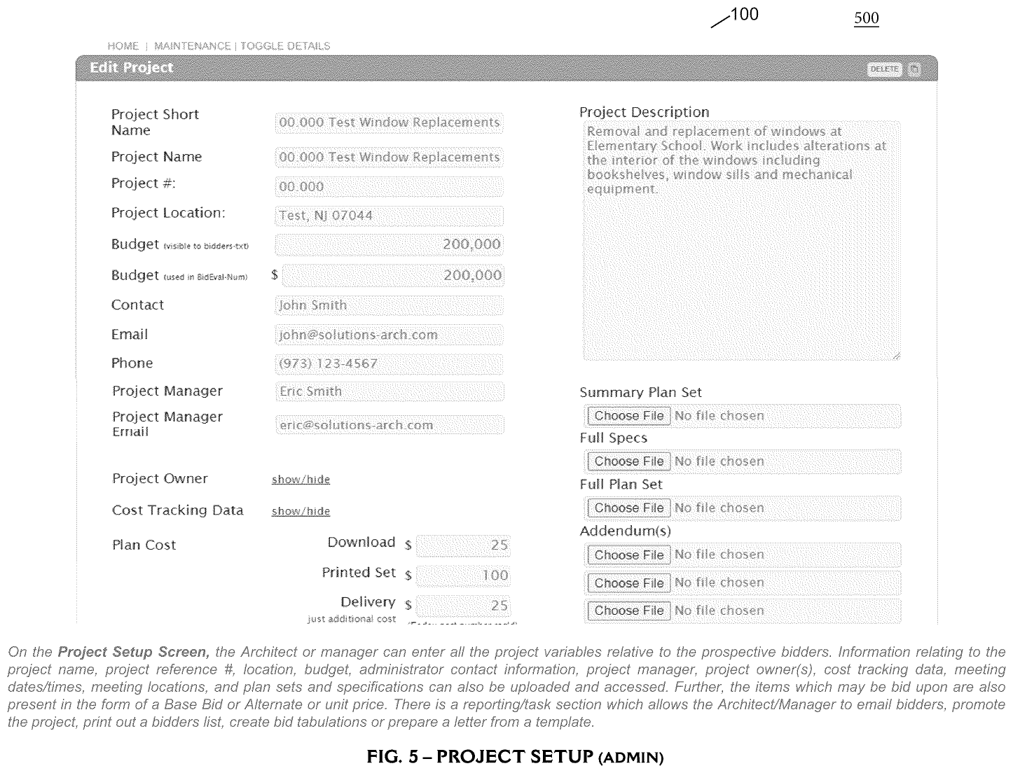

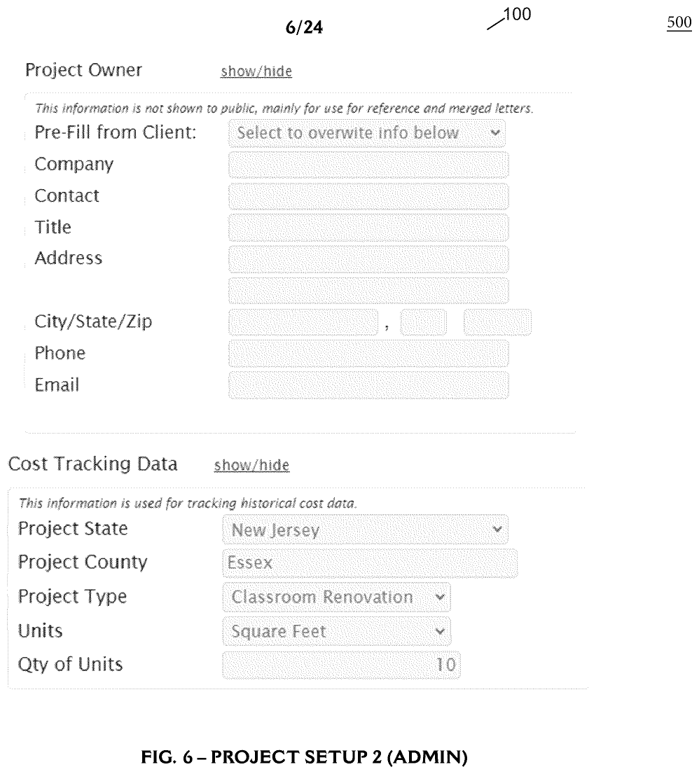

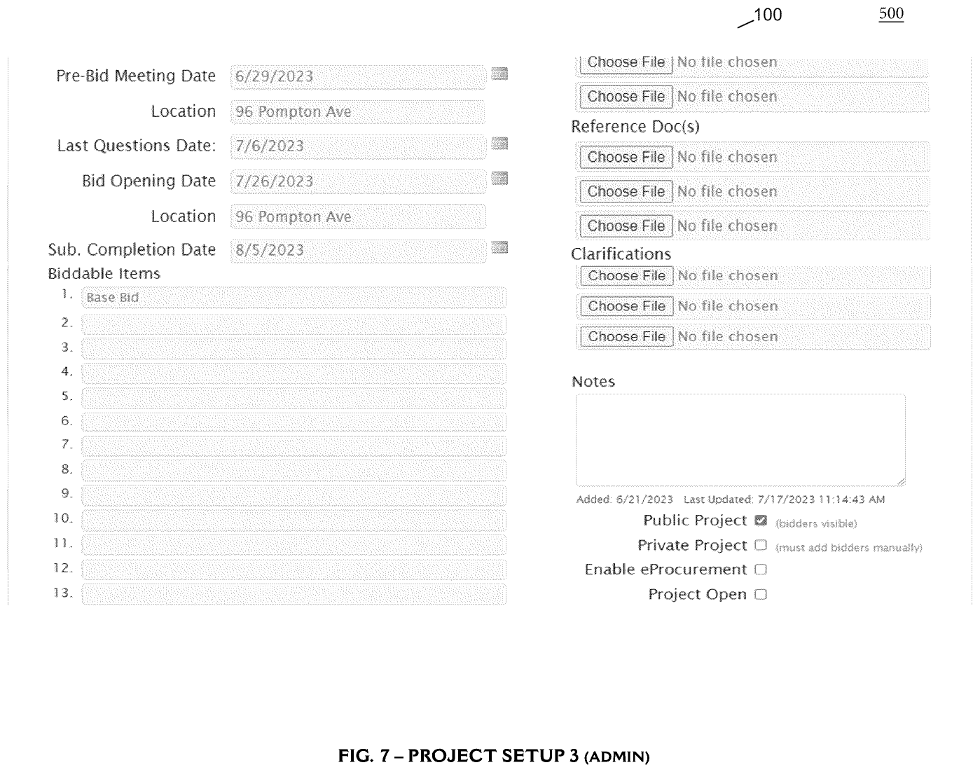

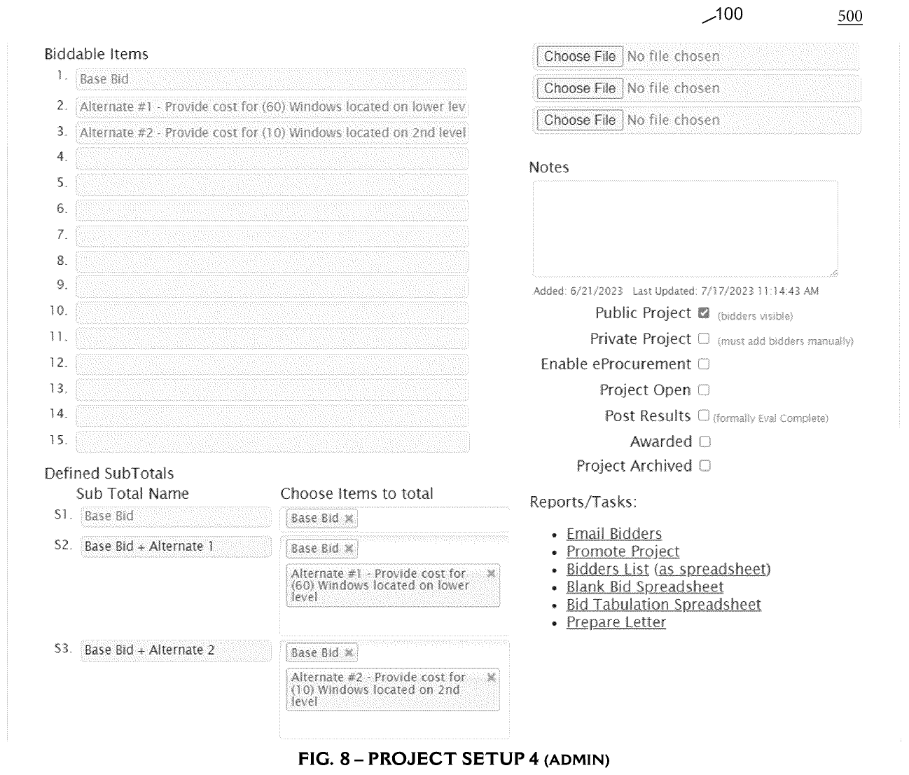

FIGS. 5-8 illustrate a device 100 showing an operational sequence 500 for a project setup that may be performed when running the bidding system. A Project Setup dashboard is an interface at which the manager can enter the project variables such that they are viewable (if selected to be viewable) by the prospective bidders. Information relating to the project name, project reference #, location, budget, administrator contact information, project manager, project owner(s), cost tracking data, meeting dates/times, meeting locations, and plan sets and specifications can also be uploaded and accessed. Further, the items which may be bid upon are also present in the form of a Base Bid or Alternate or unit price. In some embodiments, there may be various combinations of biddable items of interest to the Architect/manager/Owner. Thus, the manager can create sub-bids for certain combinations to see how those items are priced together. The Project Setup Dashboard also included several options to be checked which includes whether the project is Public or Private, if eProcurement is allowed, if the project is visible or open, if it is awarded and on what date it was awarded and to whom; or whether the project can be archived. There is a reporting/task section which allows the Architect/Manager to email bidders, promote the project, print out a bidders list, create bid tabulations or prepare a letter from a template.

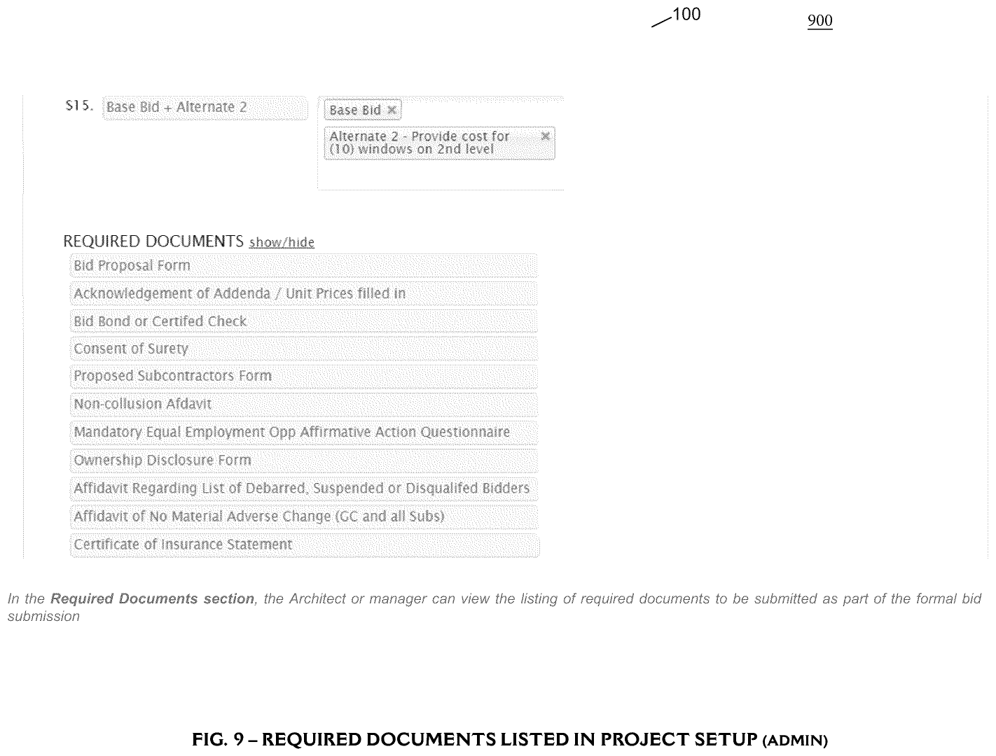

FIG. 9 is an illustration of a device 100 showing an operational sequence 900 for a project setup that may be performed when running the bidding system. In an example, the Required Document list to be included in the specifications and on the bidders checklist is displayed.

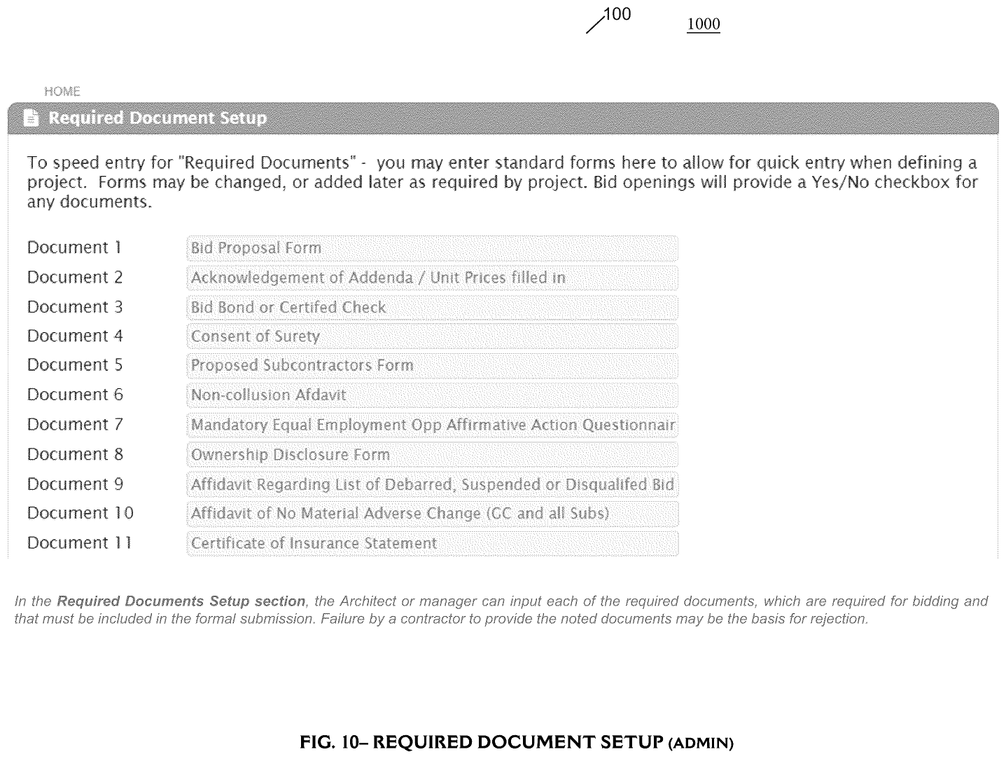

FIG. 10 is an illustration of a device 100 showing an operational sequence 1000 for a project setup that may be performed when running the bidding system. The Input Screen for Required Documents is an interface at which the manager may enter standard and mandatory documents which are required for bidding and that must be included in the formal submission. Failure by a contractor to provide the noted documents may be the basis for rejection.

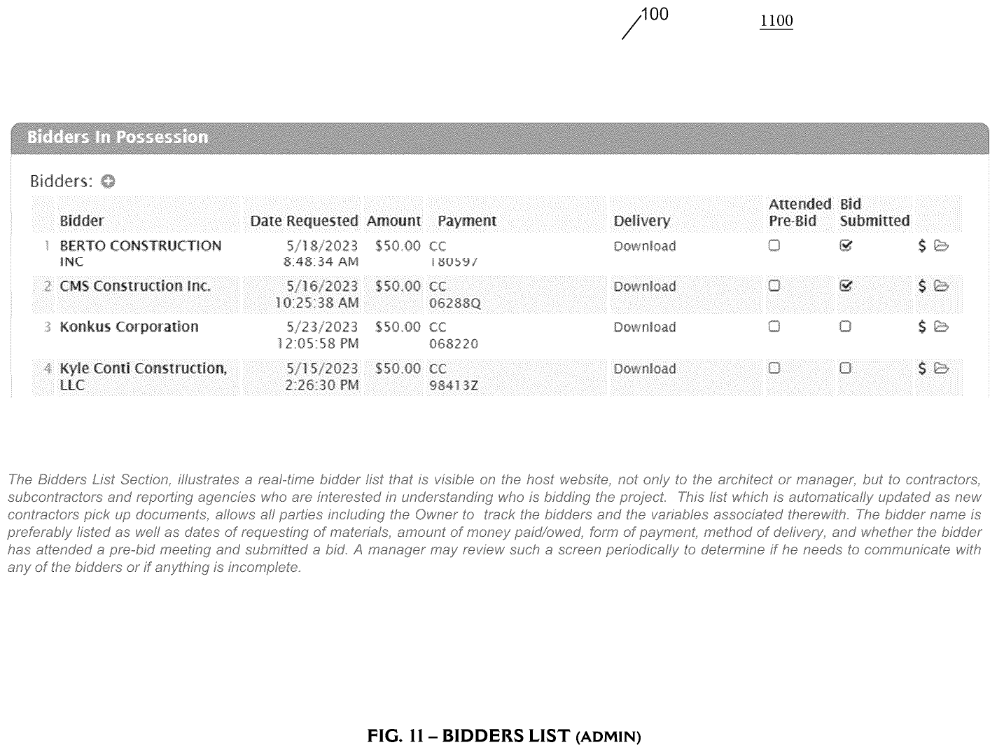

FIG. 11 is an illustration of a device 100 showing an operational sequence 1100 for a project setup having a bidders list section that may be performed when running a bidding system. A Real-time Bidder List is visible on the host website, not only to the architect or manager, but to contractors, subcontractors and reporting agencies who are interested in understanding who is bidding the project. This list which is updated as new contractors pick up documents, allows all parties including the Owner to track the bidders and the variables associated therewith. The bidder name is preferably listed as well as dates of requesting of materials, amount of money paid/owed, form of payment, method of delivery, and whether the bidder has attended a pre-bid meeting and submitted a bid. A manager may review such a screen periodically to determine if he needs to communicate with any of the bidders or if anything is incomplete.

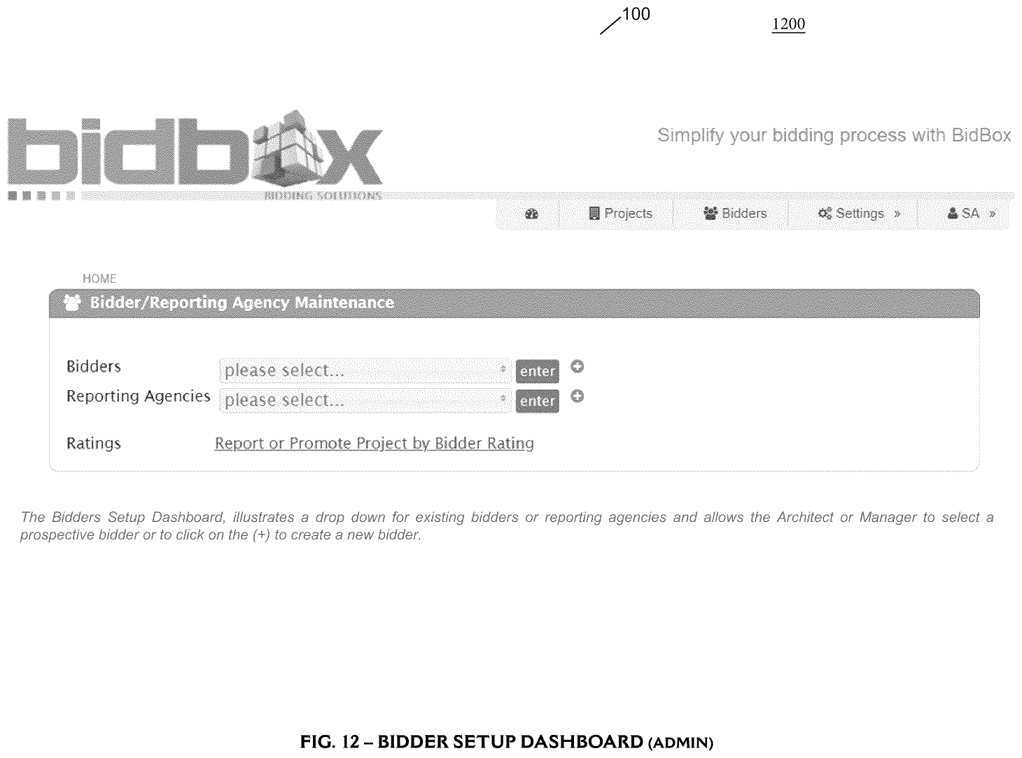

FIG. 12 is an illustration of a device 100 showing an operational sequence 1200 for a bidder setup dashboard that may be performed when running the bidding system. The Bidder/Reporting Agency Maintenance Dashboard may be accessed via a drop down for existing bidders or reporting agencies and allows the Architect or Manager to select a prospective bidder or to click on the (+) to create a new bidder.

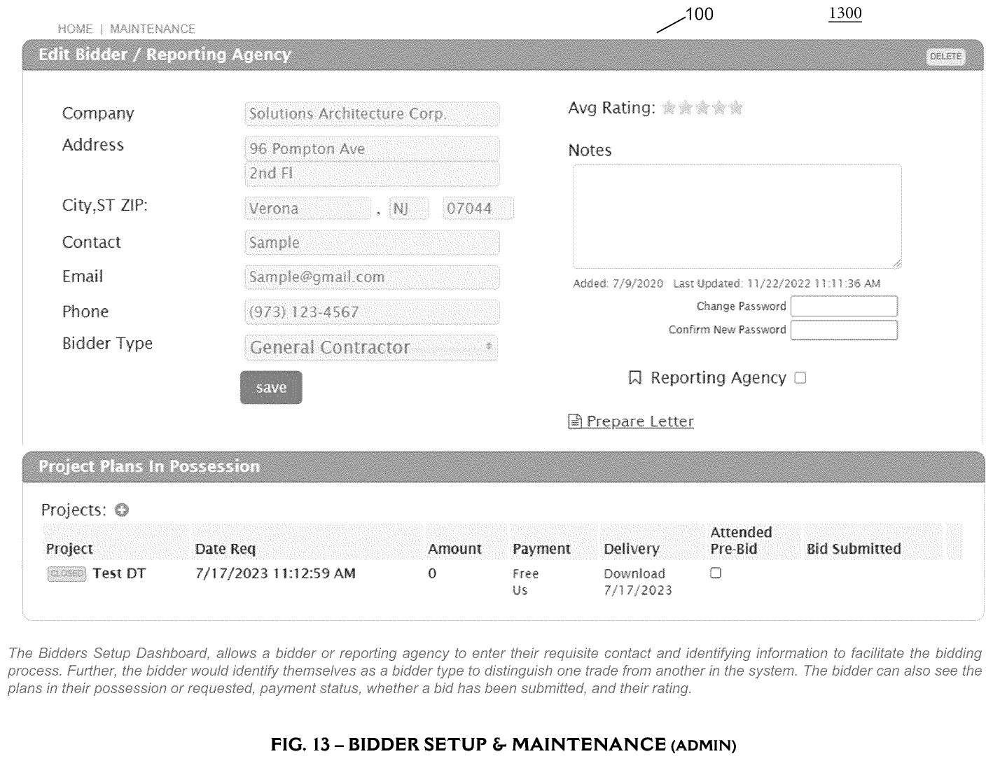

FIG. 13 is an illustration of a device 100 showing an operational sequence 1300 for a bidder setup and maintenance dashboard that may be performed when running the bidding system. A Bidder Setup dashboard allows a bidder or reporting agency to enter their requisite contact and identifying information to facilitate the bidding process. Further, the bidder would identify themselves as a bidder type to distinguish one trade from another in the system. The bidder can also see the plans in their possession or requested, payment status, whether a bid has been submitted, and their rating.

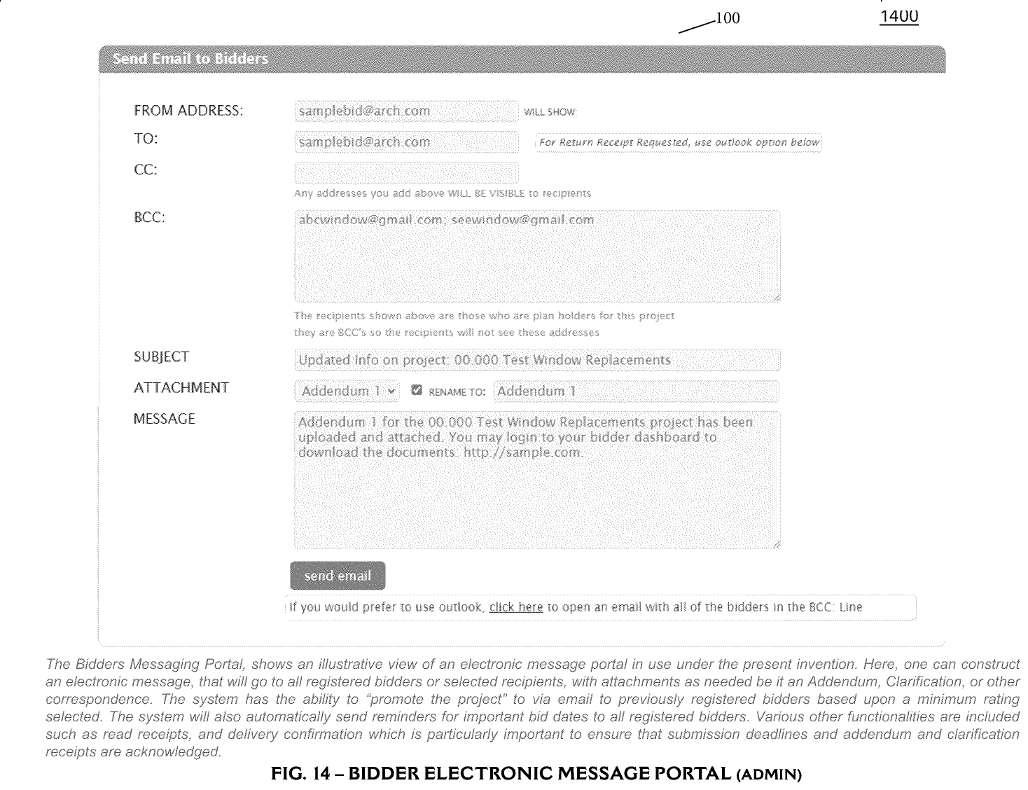

FIG. 14 is an illustration of a device 100 showing an operational sequence 1400 for a bidder electronic message portal that may be performed when running the bidding system. The Electronic Message dashboard may be used to construct an electronic message, that will go to all registered bidders or selected recipients, with attachments as needed. The system has the ability to “promote the project” via email to previously registered bidders based upon a minimum rating selected. The system will also automatically send reminders for important bid dates to all registered bidders. Various other functionalities are included such as read receipts, and delivery confirmation which is particularly important to ensure that submission deadlines and addendum and clarification receipts are acknowledged.

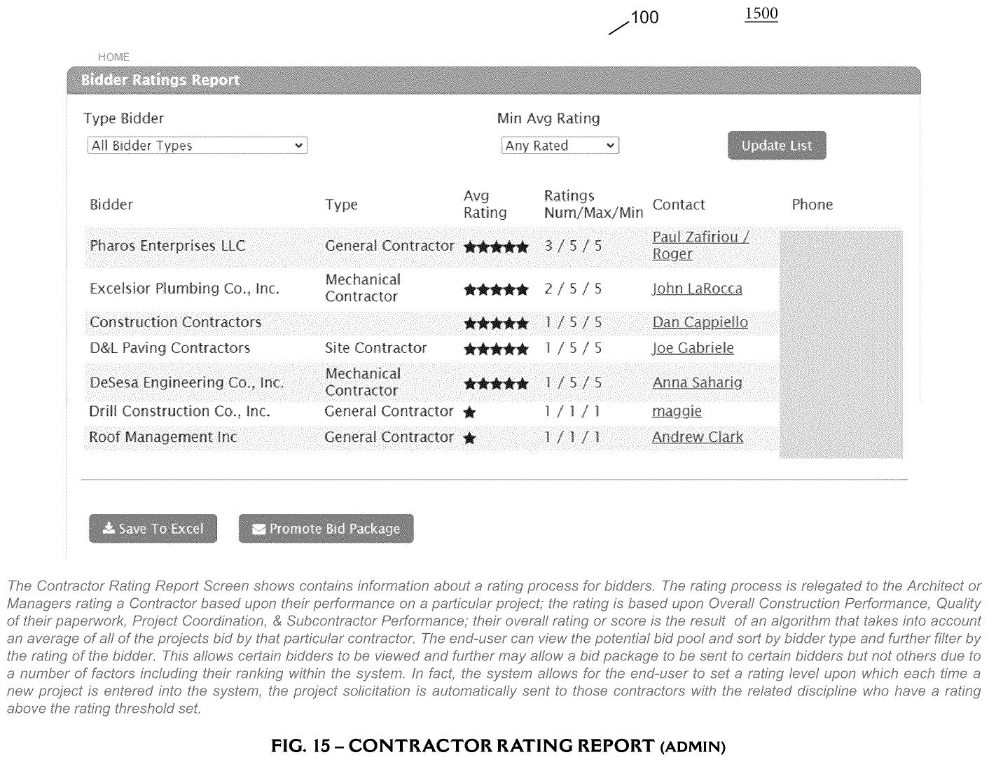

FIG. 15 is an illustration of a device 100 showing an operational sequence 1500 for contractor rating report that may be performed when running the bidding system. Contractor Ratings Report dashboard is an interface having a bidder rating report screen containing information about a rating process for bidders. The rating process is relegated to the Architect or Manager rating a Contractor based upon their performance on a particular project; the rating is based upon Overall Construction Performance, Quality of their paperwork, Project Coordination, & Subcontractor Performance; their overall rating or score is the result of an algorithm that takes into account an average of all of the projects bid by that particular contractor. The end-user can view the potential bid pool and sort by bidder type and further filter by the rating of the bidder. This allows certain bidders to be viewed and further may allow a bid package to be sent to certain bidders but not others due to a number of factors including their ranking within the system. In fact, the system allows for the end-user to set a rating level upon which each time a new project is entered into the system, the project solicitation is automatically sent to those contractors with the related discipline who have a rating above the rating threshold set.

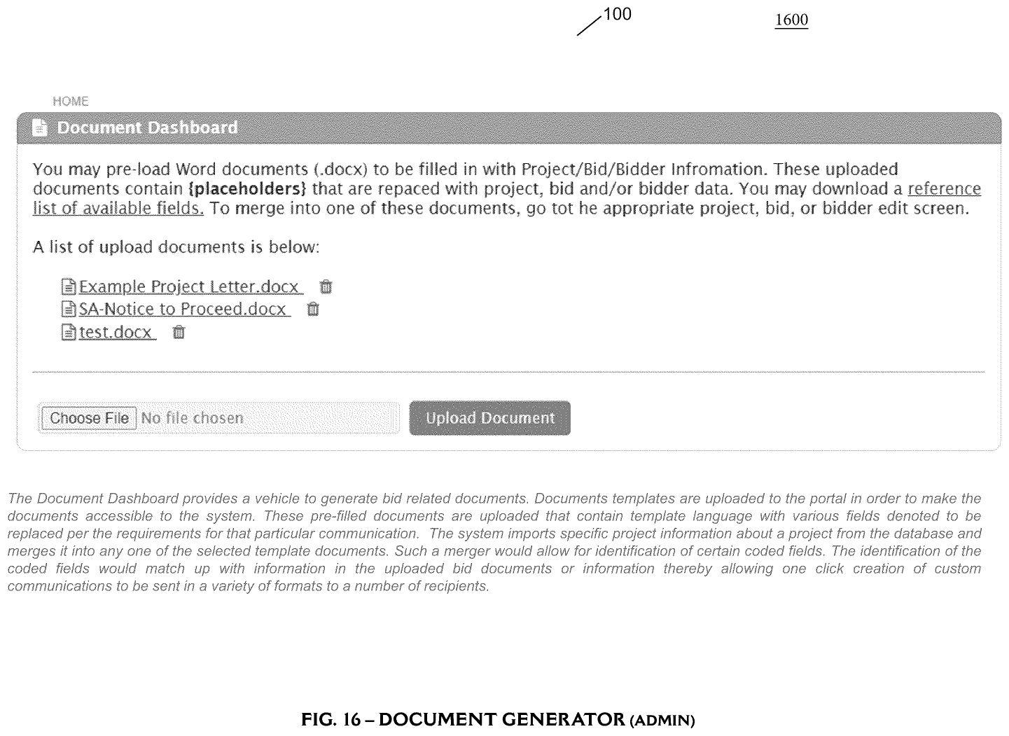

FIG. 16 is an illustration of a device 100 showing an operational sequence 1600 for a document generator that may be performed when running the bidding system. The Document Generator dashboard is where document templates are uploaded to the portal in order to make the documents accessible to the system. These pre-filled documents contain template language with various fields denoted to be replaced per the requirements for that particular communication. The system imports specific project information from the database and merges it into any one of the selected template documents. Such a merger would allow for identification of certain coded fields. The identification of the coded fields would match up with information in the uploaded bid documents or information thereby allowing one click creation of custom communications to be sent in a variety of formats to a number of recipients.

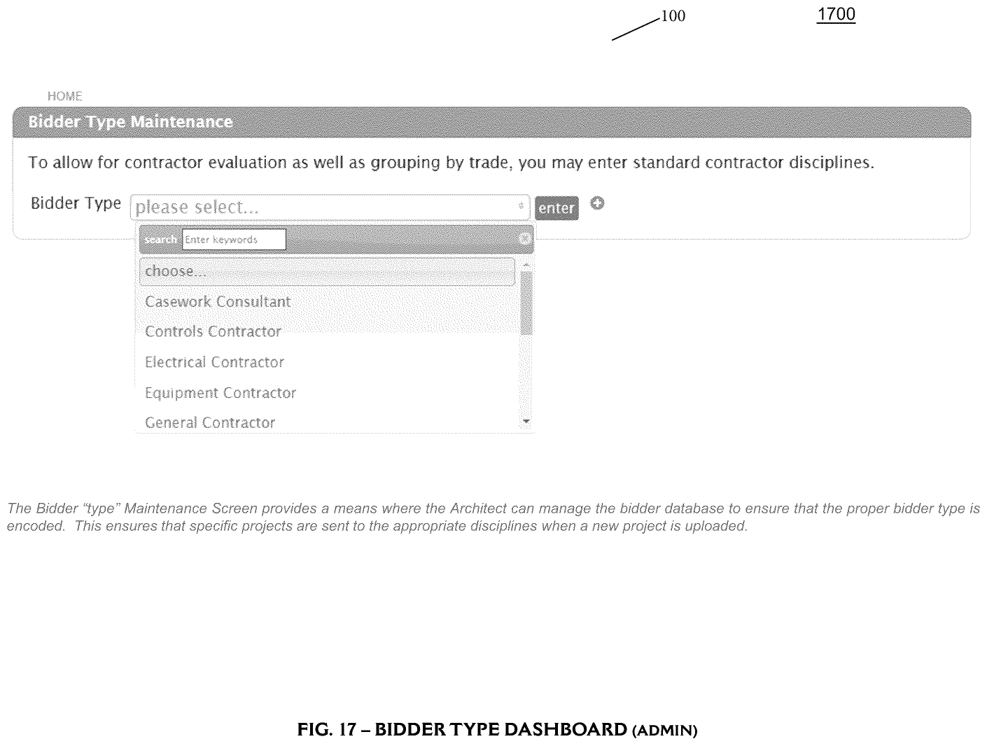

FIG. 17 is an illustration of a device 100 showing an operational sequence 1700 for a bidder type dashboard that may be performed when running the bidding system. The Bidder “Type” Maintenance dashboard is an interface at which the Architect can manage the bidder database to ensure that the proper bidder type is encoded. This ensures that specific projects are sent to the appropriate disciplines when a new project is uploaded.

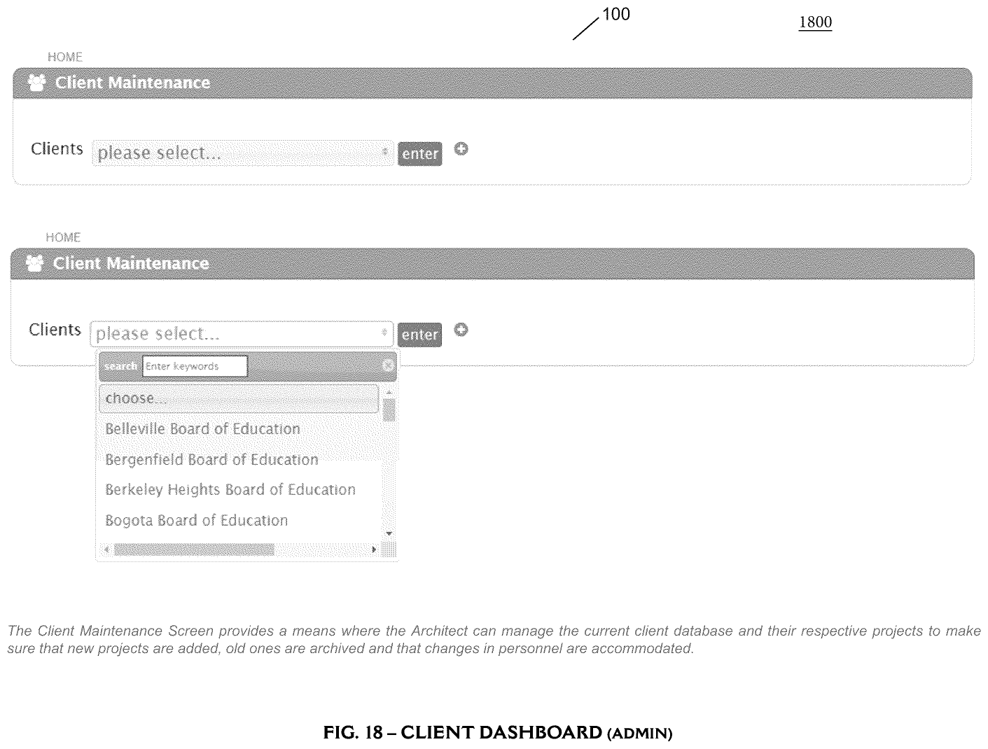

FIG. 18 is an illustration of a device 100 showing an operational sequence 1800 for a client dashboard that may be performed when running the bidding system. The Client Maintenance dashboard is an interface at which the Architect can manage the current client database and their respective projects to make sure that new projects are added, old ones are archived and that changes in personnel are accommodated.

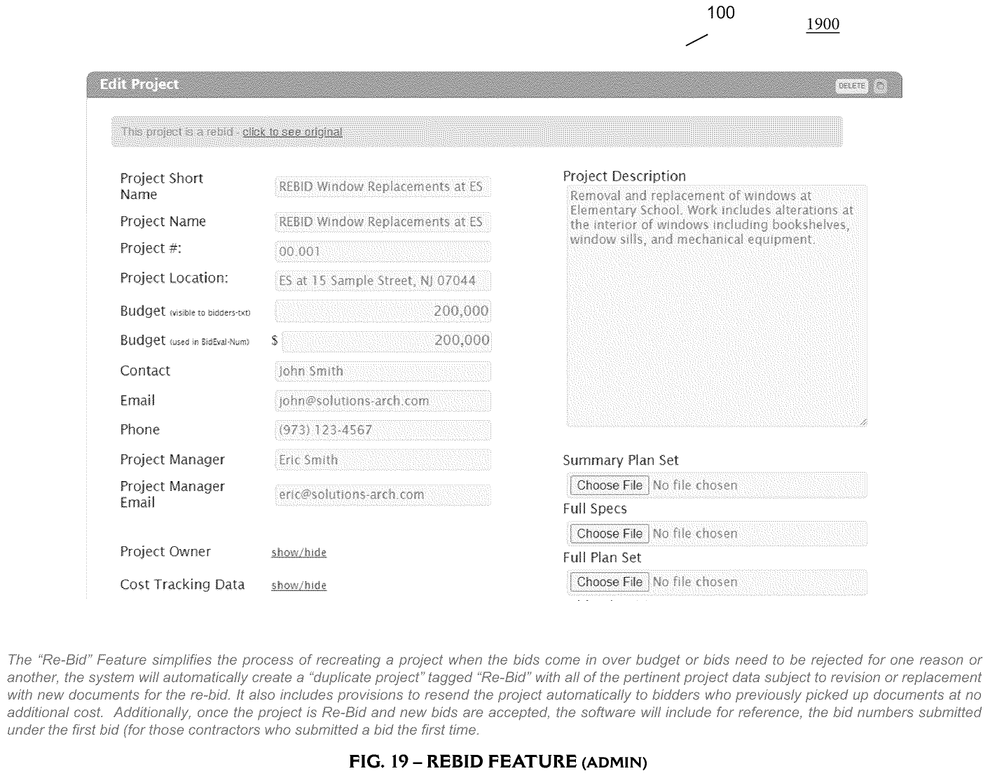

FIG. 19 is an illustration of a device 100 showing an operational sequence 1900 for a rebid feature that may be performed when running the bidding system. The “Re-Bid” Feature simplifies the process of recreating a project should a project come in over budget or bids need to be rejected for one reason or another, the system will automatically create a “duplicate project” tagged “Re-Bid” with all of the pertinent project data subject to revision or replacement with new documents for the re-bid. It also includes provisions to resend the project automatically to bidders who previously picked up documents at no additional cost. Additionally, once the project is Re-Bid and new bids are accepted, the software will include for reference, the bid numbers submitted under the first bid (for those contractors who submitted a bid the first time.

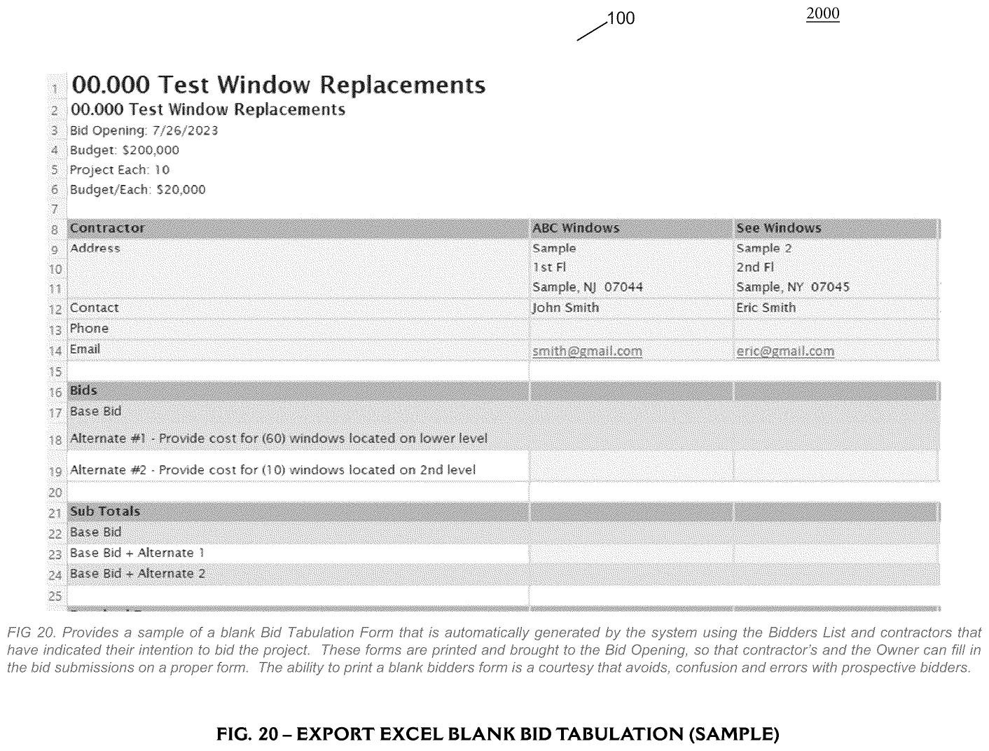

FIG. 20 is an illustration of a device 100 showing an operational sequence 2000 for an export excel blank tabulation sample that may be performed when running the bidding system. A sample of a blank Bid Tabulation Form is automatically generated by the system using the Bidders List and contractors that have indicated their intention to bid the project. These forms are printed and brought to the Bid Opening, so that contractors and the Owner can fill in the bid submissions on a proper form. The ability to print a blank bidders form is a courtesy that avoids, confusion and errors with prospective bidders.

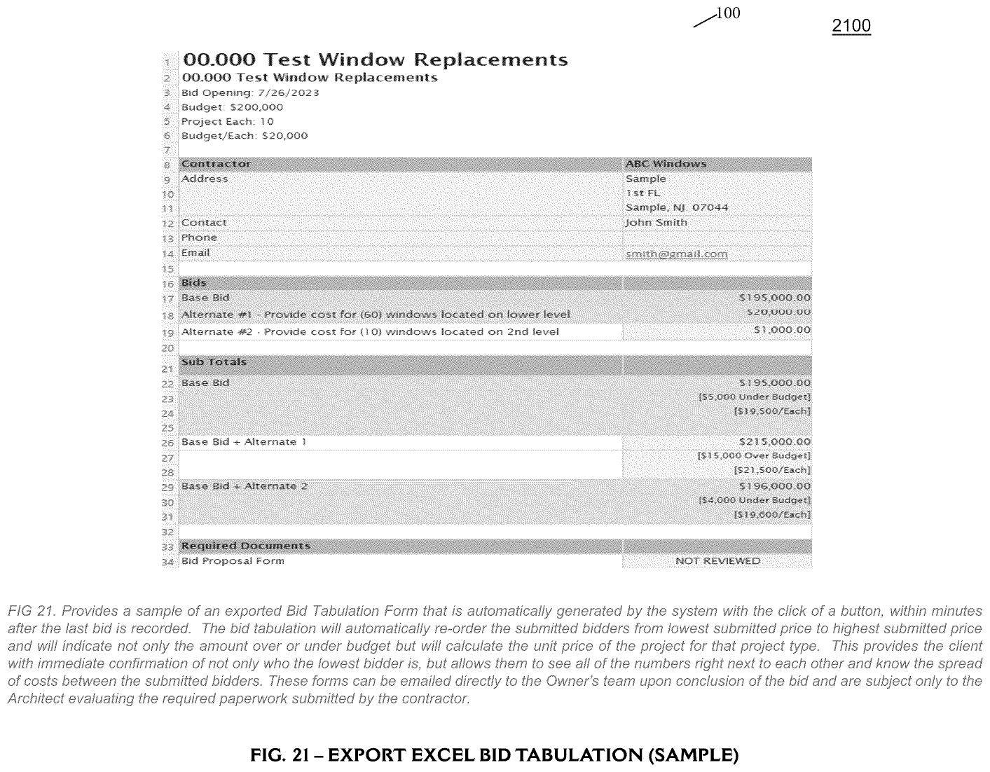

FIG. 21 is an illustration of a device 100 showing an operational sequence 2100 for an export excel bid tabulation sample that may be performed when running the bidding system. A sample of an exported Bid Tabulation Form is automatically generated by the system with the click of a button, within minutes after the last bid is recorded. The bid tabulation will automatically re-order the submitted bidders from lowest submitted price to highest submitted price and will indicate not only the amount over or under budget but will calculate the unit price of the project for that project type. This provides the client with immediate confirmation of not only who the lowest bidder is, but allows them to see all of the numbers right next to each other and know the spread of costs between the submitted bidders. These forms can be emailed directly to the Owner's team upon conclusion of the bid and are subject only to the Architect evaluating the required paperwork submitted by the contractor.

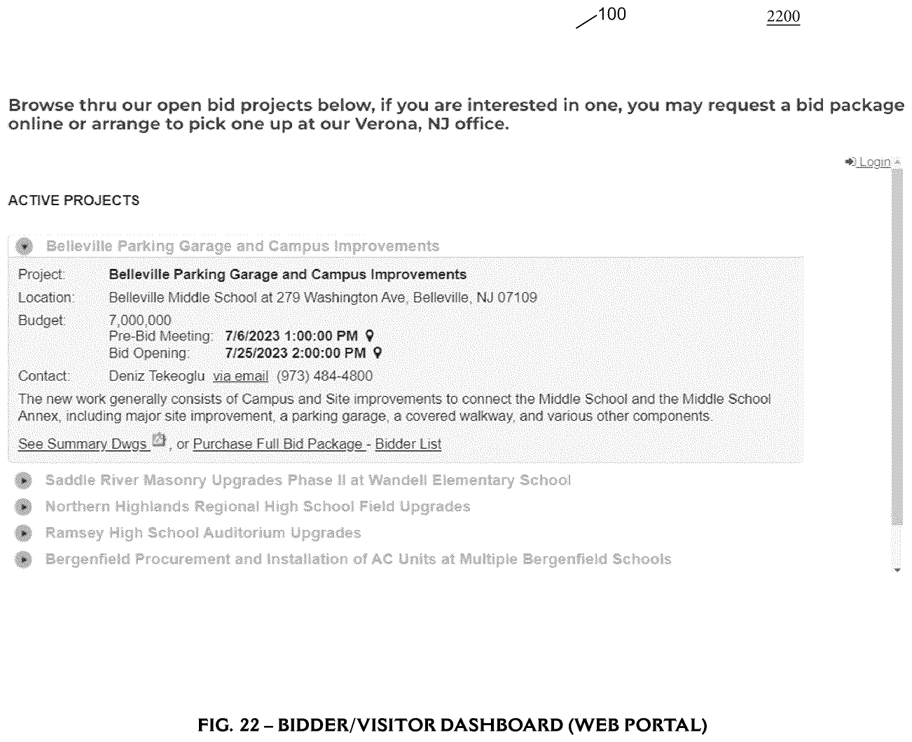

FIG. 22 is an illustration of a device 100 showing an operational sequence 2200 for a bidder and visitor dashboard that may be performed when running the bidding system. This interface allows a user to view displayed bid projects. Informative data is displayed to a user such as a project name, location, budget, and/or contact information.

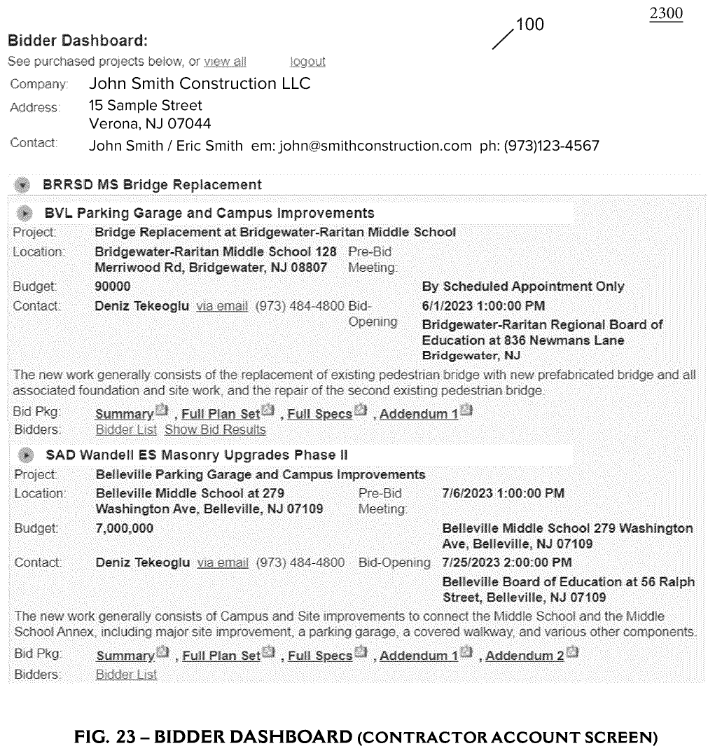

FIG. 23 is an illustration of a device 100 showing an operational sequence 2300 for a bidder dashboard that may be performed when running the bidding system. Purchased projects may be displayed to a user through the GUI. Data related to the company name, address, and contact information may be displayed to a user.

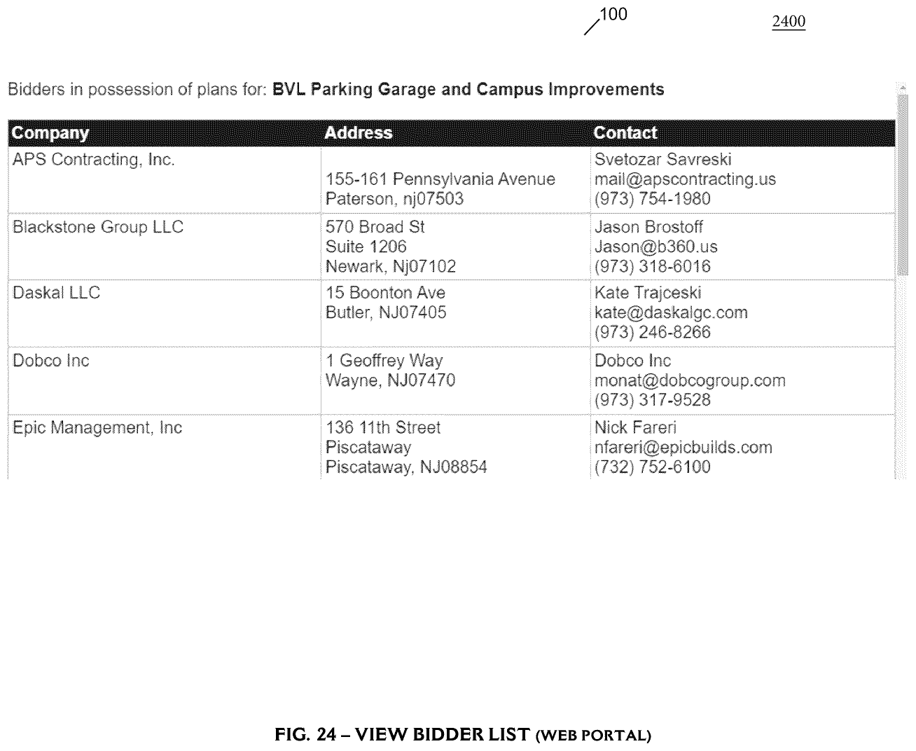

FIG. 24 is an illustration of a device 100 showing an operational sequence 2400 for a view bidder list that may be performed when running the bidding system.

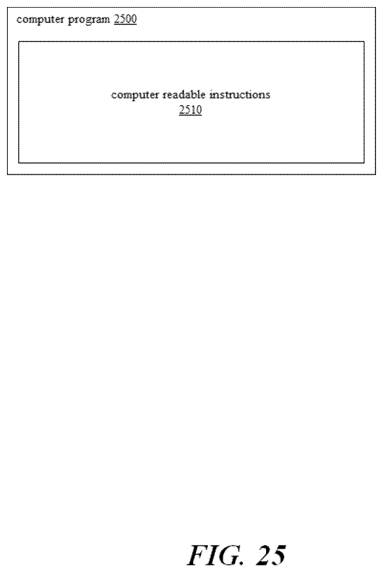

FIG. 25 is a block diagram that describes a computer program 2500, according to some embodiments of the present disclosure. In some embodiments, the computer program 2500 may also include computer readable instructions 2510, which when executed by a processor, cause the processor to perform the steps of establishing, via the processor, a bid portal for at least one project. A step includes soliciting, via the processor, an invitation to make a bid by at least one bidder. Another step includes receiving, via the processor, at least one bid for the at least one project. Another step includes analyzing, via the processor, the at least one bid for compliance with the bid portal. Another step includes accepting, via the processor, the at least one bid for inclusion in a bid pool. Another step includes calculating a cost-per-unit for the project based on the bid, a project type, a unit of measurement, and a quantity of units. Another step includes displaying the bids in order from lowest to highest based on the cost-per-unit.

In some embodiments, the step includes notifying, via the processor, of a selection of at least one bid for the at least one project. In some embodiments, the notifying may be completed via an electronic message. In some embodiments, at least a bid form, bid bond, consent of surety, notice of classification, non-collusion affidavit, certificate of insurance or a combination thereof. In some embodiments, the step of sending an electronic message to the at least one bidder, via the processor, to update a status of the bid portal may occur. In some embodiments, the at least one bidder may include a qualifying rank.

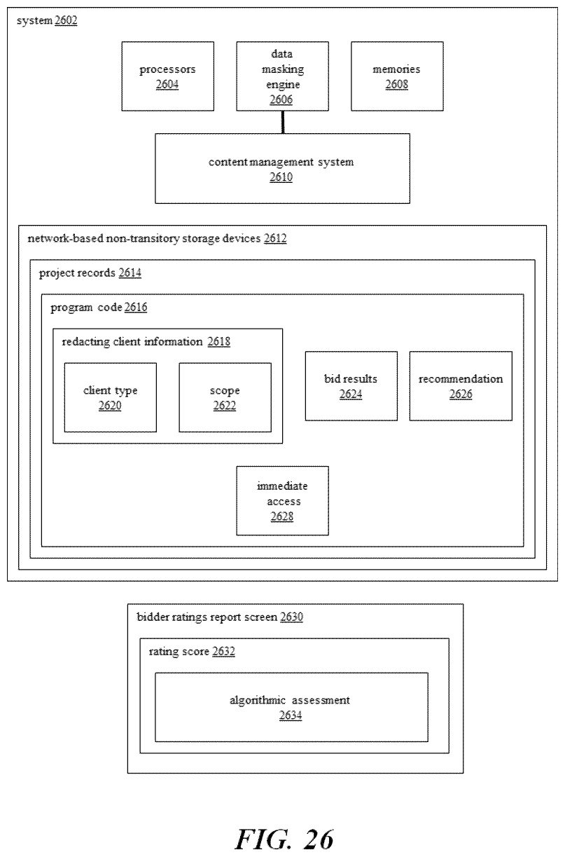

FIG. 26 is a block diagram that describes a system 2602, according to some embodiments of the present disclosure. In some embodiments, the system 2602 may include one or more processors 2604, a data masking engine 2606, one or more memories 2608, a content management system 2610, and one or more network-based non-transitory storage devices 2612. The system 2602 may also include a content management system 2610 in bidirectional communication with the data masking engine 2606 and the one or more processors 2604. The one or more network-based non-transitory storage devices 2612 may include a collection of project records 2614 stored thereon.

In some embodiments, the collection of project records 2614 may also include program code 2616 executable by the one or more processors 2604 via the one or more memories 2608 to implement a method for bid management. The program code 2616 may include bid results 2624, a recommendation 2626 for an award of the project by the content server whenever the standardized format of the updated information about the project conditions and the standardized format of the bid submissions, and immediate access 2628 to up-to-date project bidding information. The program code 2616 may also include redacting client information 2618 from each of the bid submissions, using the data masking engine 2606 and the content management system 2610.

In some embodiments, the step of storing information in the one or more network-based non-transitory storage devices 2612 in a standardized format about a project may occur. In a step, providing remote access to users over a network so one or more of the users can access updated information about project conditions in the collection of the project records 2614 in real-time through a graphical user interface (GUI) occurs. A professional may provide the updated information about the project conditions in a non-standardized format.

In some embodiments, providing remote access to the professional over the network so that bid submissions may be entered for the project using the GUI. Each of the bid submissions comprises. Each of the bid submissions comprises at least a bid form, a bid bond, a certificate of insurance, a consent of surety, a notice of classification, and a non-collusion affidavit. At a step, presenting a bidder ratings report screen 2630 is viewable via the GUI. The redacting client information 2618 may include a client type 2620. The redacting client information 2618 may also include a scope 2622 of work to be performed, a fee type, a work phase breakdown, and a billing worksheet.

In some embodiments, a step includes converting, by a content server, the non-standardized format of the updated information about the project conditions to a standardized format and the nonstandardized format of the bid submissions into a standardized format. In another step, storing the standardized format of the updated information about the project conditions and the standardized format of the bid submissions in the collection of project records 2614 occurs.

In some embodiments, a step includes automatically generating a bid tabulation worksheet and automatically populating form letters based on the standardized format of the updated information about the project conditions and the standardized format of the bid submissions. Another step includes, automatically generating an email message and transmitting the email message to all of the users over the network in real time, so that each user has immediate access to up-to-date project bidding information.

In some embodiments, the bidder ratings report screen 2630 may include a rating score 2632 for each of the one or more users. The rating score 2632 may also include an algorithmic assessment 2634 of a competitiveness of each of the bid submissions received for the project, a completion rate associated with each of the one or more users for the project, and a quantity of subcontractors used for the project. Rating score for each of the one or more users may comprise a hybrid model integrating feedforward neural networks for the competitiveness assessment, recurrent neural networks for the completion rate, and graph neural networks for a subcontractor analysis to yield a rating score. In some embodiments, an output of a node in the feedforward neural network, considering the ith neuron in layer 1, can be expressed as Equation 1:

zᵢ^{(l)}=Σⱼ₌₁ⁿ^{^{(l-1)}}·wᵢⱼ^{(l)}aⱼ^{(l-1)}+bᵢ^{(l)}.

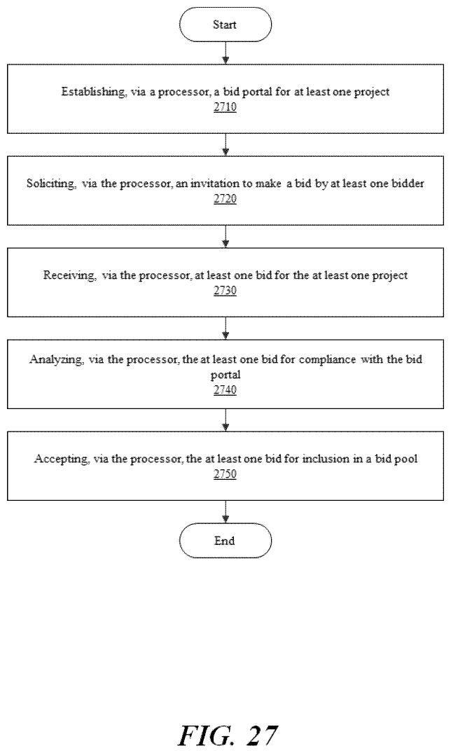

FIG. 27 is a flowchart that describes a bidding method using the bidding system, according to some embodiments of the present disclosure. In some embodiments, at 2710, the method may include establishing, via a processor, a bid portal for at least one project. At 2720, the method may include soliciting, via the processor, an invitation to make a bid by at least one bidder. At 2730, the method may include receiving, via the processor, at least one bid for the at least one project. At 2740, the method may include analyzing, via the processor, the at least one bid for compliance with the bid portal. At 2750, the method may include accepting, via the processor, the at least one bid for inclusion in a bid pool. The steps of, the method may include 2710 to 2750. The bid portal comprises a named, date, location, budget, project contact, and diagrams. The at least one bidder may meet an eligibility criteria. If non-compliance may be noted, then a notification may be send to the at least one bidder.

The bidding system may incorporate hardware solutions to redact client information from bid submissions containing sensitive details such as client type, scope of work, fee type, work phase breakdown, and a billing worksheet. Document redaction software tools equipped with specific functionalities for sensitive data identification and removal, including the ability to redact client-specific information, are commonly used for this purpose. These software solutions enable automated or manual redaction, ensuring the confidentiality of sensitive client details while maintaining the integrity and usability of the bid submissions. Furthermore, a data masking engine is an anonymization hardware tools that can be utilized, along with a content management system (CMS) that incorporate redaction features. A data masking engine is a sophisticated tool designed to protect sensitive information within datasets by altering or obscuring identifiable data elements while maintaining the overall structure and usability of the data for authorized use. These systems empower users to selectively hide or modify sensitive information within documents, maintaining compliance with privacy regulations. Advanced technologies employing Artificial Intelligence (AI) or Machine Learning (ML) algorithms provide automated identification and redaction capabilities for sensitive client data within bid submissions. These tools can analyze and mask client-related details based on predefined criteria or patterns, ensuring secure redaction while preserving document structure and usability. Customized scripting or programming solutions may also be developed using programming languages such as Python or JavaScript to create tailored redaction processes for bid submissions. These solutions can identify and redact specific client information based on defined rules and criteria.

The algorithms for generating rating scores in the bidder ratings report could involve complex mathematical models and data analysis techniques. One potential algorithm of the bidding system for competitiveness assessment might employ machine learning methodologies, utilizing predictive modeling or regression techniques to evaluate bid submissions. This algorithm could involve feature extraction from bid data, applying statistical analysis and/or neural networks to predict competitiveness based on historical bid patterns, bid amounts, project complexity, and other relevant variables. For computing completion rates, a statistical algorithm might utilize survival analysis techniques such as Kaplan-Meier estimators or Cox proportional hazards models. This approach could factor in project timelines, milestones achieved, and project success rates over time to determine a user's completion rate for projects undertaken. Regarding subcontractor quantity assessment, a clustering or network analysis algorithm might be used to examine collaborative relationships within project data. This algorithm could analyze project structures, identifying subcontractor connections, and quantifying their involvement, potentially using graph theory or clustering algorithms to ascertain the number and significance of subcontractor interactions. Combining these highly technical algorithms could involve complex data integration, feature engineering, statistical modeling, and machine learning methodologies. In the context of generating rating scores for bidder evaluations involving competitiveness assessment, completion rates, and subcontractor quantity, several types of neural networks could be effective.

An example of a neural network employed by the bidding system includes Feedforward Neural Networks (FNNs). The output of a node in a feedforward neural network, considering the ith neuron in layer 1, can be expressed as Equation 1: zᵢ^{(l)}=Σⱼ₌₁ⁿ^{^{(l-1)}}·wᵢⱼ^{(l)}·aⱼ^{(l-1)}+bᵢ^{(l)}. Where: zᵢ^{(l)} is the weighted input to node i in layer l. wᵢⱼ^{(l)} represents the weight connecting neuron i in layer l to neuron j in the previous layer. aⱼ^{(l)}−denotes the activation of neuron j in the previous layer. bᵢ^{(l)} is the bias term for neuron i in layer l. The activation function a is applied to zᵢ^{(l)} to compute the output of neuron i in layer l.

These traditional neural networks consist of input, hidden, and output layers and can perform well for regression tasks. FNNs could be employed to predict competitiveness scores based on historical bid patterns and various project-related features. Another example of a neural network employed by the bidding system includes a Recurrent Neural Network (RNNs). RNNs, especially Long Short-Term Memory (LSTM) or Gated Recurrent Unit (GRU) variants, are suitable for sequential data analysis. They could be utilized to analyze project completion timelines and success rates, taking into account temporal dependencies to calculate completion rates for users. The recurrent update in an RNN of the bidding system can be represented as Equation 2:hₜ=activation(Wₓₕxₜ+Wₕₕhₜ₋₁+bₕ).

Where: hₜ is the hidden state at time step t. xₜ is the input at time step t. Wₓₕ and Wₕₕ represent the weight matrices for input-to-hidden and hidden-to-hidden connections, respectively. bₕ is the bias term. The activation function a operates on the combined input.

Another example of a neural network employed by the bidding system includes Convolutional Neural Networks (CNNs). While typically used for image analysis, CNNs can also be adapted for certain structured data. In this context, they might assist in identifying complex patterns within bid submission data, especially when the features involve structured information. Another example of a neural network employed by the bidding system includes Graph Neural Networks (GNNs). Given the relational nature of subcontractor interactions and collaborative relationships within projects, GNNs could be employed to analyze the network structure of subcontractor connections, quantifying subcontractor involvement within the project. Another example of a neural network employed by the bidding system includes Hybrid Architectures. Combining different neural network architectures or employing ensemble methods could leverage the strengths of various networks. For instance, a hybrid model integrating FNNs for competitiveness assessment, RNNs for completion rates, and GNNs for subcontractor analysis could yield a comprehensive rating score.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer program embodied in a non-transitory computer-readable medium comprising computer readable instructions, which when executed by a processor, cause the processor to perform the steps of:
establishing, via the processor, a bid portal for at least one project;
soliciting, via the processor, an invitation to make a bid by at least one bidder;
receiving, via the processor, at least one bid for the at least one project;
analyzing, via the processor, the at least one bid for compliance with the bid portal;
accepting, via the processor, the at least ne bid for inclusion in a bid pool;
calculating a cost-per-unit for the project based on the bid, a project type, a unit of measurement, and a quantity of units; and
displaying the bids in order from lowest to highest based on the cost-per-unit.

2. The medium of claim 1 further comprising the step of:
notifying, via the processor, of a selection of at least one bid for the at least one project.

3. The medium of claim 2 wherein the notifying is completed via an electronic message.

4. The medium of claim 1 wherein the at least one bid comprises at least a bid form, bid bond, consent of surety, notice of classification, non-collusion affidavit, certificate of insurance or a combination thereof.

5. The medium of claim 1 further comprising the step of:
sending an electronic message to the at least one bidder, via the processor, to update a status of the bid portal.

6. The medium of claim 1 wherein the at least one bidder has a qualifying rank.

7. A system for bid management, the system comprising:
one or more processors;
a data masking engine;
a content management system, the content management system is in bidirectional communication with the data masking engine and the one or more processors;
one or more memories; and
one or more network-based non-transitory storage devices having a collection of project records stored thereon and containing program code executable by the one or more processors via the one or more memories to implement a method for bid management, the method consisting of:
storing information in the one or more network-based non-transitory storage devices in a standardized format about a project;
providing remote access to users over a network so one or more of the users can access updated information about project conditions in the collection of the project records in real-time through a graphical user interface (GUI), wherein a professional provides the updated information about the project conditions in a non-standardized format;
providing remote access to the professional over the network so that bid submissions may be entered for the project using the GUI, wherein each of the bid submissions comprises at least a bid form, a bid bond, a certificate of insurance, a consent of surety, a notice of classification, and a non-collusion affidavit;
presenting a bidder ratings report screen viewable via the GUI, wherein the bidder ratings report screen contains a rating score for each of the one or more users, and wherein rating score for each of the one or more users comprises an algorithmic assessment of a competitiveness of each of the bid submissions received for the project, a completion rate associated with each of the one or more users for the project, and a quantity of subcontractors used for the project, and
providing a hybrid model integrating a feedforward neural network for the competitiveness assessment, a recurrent neural network for the completion rate, and a graph neural network for a subcontractor analysis to yield a rating score;
redacting client information from each of the bid submissions, using the data masking engine and the content management system, wherein the client information comprises a client type, a scope of work to be performed, a fee type, a work phase breakdown, and a billing worksheet;
converting, by a content server, the non-standardized format of the updated information about the project conditions to a standardized format and the nonstandardized format of the bid submissions into a standardized format;
storing the standardized format of the updated information about the project conditions and the standardized format of the bid submissions in the collection of project records;
automatically generating a bid tabulation worksheet and automatically populating form letters based on the standardized format of the updated information about the project conditions and the standardized format of the bid submissions;
automatically generating an email message containing bid results and a recommendation for an award of the project by the content server whenever the standardized format of the updated information about the project conditions and the standardized format of the bid submissions has published; and
automatically transmitting the email message to all of the users over the network in real time, so that each user has immediate access to up-to-date project bidding information.

8. The system for bid management of claim 7 wherein an output of a node in the feedforward neural network is expressed as Equation 1:
zᵢ^{(l)}=Σⱼ₌₁ⁿ^{^{(l-1)}}wᵢⱼ^{(l)}·aⱼ^{(l-1)}+bᵢ^{(l)}.

9. The system for bid management of claim 7 wherein the completion rate may be updated with a recurrent update represented as Equation 2: hₜ=activation(Wₓₕx₁+Wₕₕhₜ₋₁+bₕ).

10. A computer implemented method of bid management of at least one user, the method comprising the steps of:
establishing, via a processor, a bid portal for at least one project,
wherein the bid portal comprises a named, date, location, budget, project contact, and diagrams;
soliciting, via the processor, an invitation to make a bid by at least one bidder,
wherein the at least one bidder meets an eligibility criteria;
receiving, via the processor, at least one bid for the at least one project;
analyzing, via the processor, the at least one bid for compliance with the bid portal,
wherein if non-compliance is noted, then a notification is send to the at least one bidder; and
accepting, via the processor, the at least one bid for inclusion in a bid pool.
